(19) United States
(12) Patent Application Publication
(10) Pub. No.: US 2026/0258583 A1
(43) Pub. Date: Sep. 3, 2026

(54) HYBRID FABRICS OF CARBON AND ULTRA-HIGH MOLECULAR WEIGHT POLYETHYLENE FIBERS FOR USE IN IMPACT RESISTANT ARTICLES

(71) Applicant: KORDSA TEKNIK TEKSTIL ANONIM SIRKETI, Kocaeli (TR)

(72) Inventors: Kadir DEMIRCI, Kocaeli (TR); Okan ATAMAN, Kocaeli (TR); Sevim ORS SUTUVEN, Kocaeli (TR); Denis GRANGER, Istanbul (TR); Mary SHAFER, Quakertown, PA (US)

(73) Assignee: KORDSA TEKNIK TEKSTIL ANONIM SIRKETI, Kocaeli (TR)

(21) Appl. No.: 18/878,882

(22) PCT Filed: Jun. 12, 2023
(86) PCT No.: PCT/TR2023/050552

§ 371 Date: Dec. 25, 2024

(30) Foreign Application Priority Data
Jul. 7, 2022 (TR) 2022/011268

(51) Int. Cl. D03D 15/275; D03D 15/283; D03D 15/41

(52) U.S. Cl. CPC D03D 15/275; D03D 15/283; D03D 15/41; D10B 2101/12; D10B 2321/0211

(57) ABSTRACT

A hybrid fabric including carbon fibers and UHMWPE fibers is provided. Where UHMWPE fibers are twisted in order to improve their tensile strength and thus improve the impact resistance properties of the hybrid fabric. The hybrid fabric is preferably a woven fabric including 50-70% carbon fibers and 30-50% UHMWPE fibers by weight. The hybrid fabric can be used in composites for producing impact resistant articles such as protective shields for battery packs in electric vehicles.

### CROSS REFERENCE TO THE RELATED APPLICATIONS

This application is the phase entry of International Application No. PCT/TR2023/050552, filed on Jun. 12, 2023, which is based upon and claims priority to Turkish Patent Application No. 2022/011268, filed on Jul. 7, 2022, the entire contents of which are incorporated herein by reference.

### TECHNICAL FIELD

The present invention relates to a hybrid fabric of carbon and ultra-high molecular weight polyethylene (UHMWPE) fibers having improved impact resistance performance.

### BACKGROUND

Electric vehicles, due to their cleaner and more efficient drive systems, offer one of the most promising alternatives to vehicles that use internal combustion engines. In a typical electric vehicle, the battery pack is mounted to the vehicle's floor in a location intended to be as unobtrusive as possible, as well as to protect the battery pack from front and rear impact accidents. However, the battery pack can still be deformed by ground impacts, which are the debris and stones on the roads which can hit and penetrate into the battery pack. Ground impacts can cause damage to the battery pack structure as well as cause fire accidents. Therefore, most electric vehicles include a protective material, for example an impact resistant article mounted under the electric vehicle which is shaped and positioned to cover and protect the battery pack from ground impact.

Generally, carbon fiber composites are utilized in said impact resistant articles due to their high specific strengths and stiffness. However, carbon fiber composites are likely to experience decline in mechanical properties, and even catastrophic failure in service caused by delaminations or cracks due to their inherent brittleness and poor toughness when suffering from localized impact damage such as road debris. In order to solve this problem, hybrid composites, namely composites including carbon fiber and other fibers have been proposed. The most common used fibers are glass fibers, polyaramid, natural fibers such as flax or basalt, and polyolefin fibers, such as polyethylene fibers. Among these, ultra-high molecular weight (UHMWPE) fibers are a good candidate due to their low, high axial specific strength and modulus, high elongation, and excellent energy absorption performance (Hu, Yuan, et al. “Damage tolerance of 2-dimentional UHMWPE/CF hybrid woven laminates subjected to low-velocity impact.” Materials & Design 191 (2020): 108604).

Examples of hybrid articles including carbon and UHMWPE fibers found in the state of the art are given below.

EP 0 310 203 discloses combinations of filaments having substantially different damping responses to mechanical vibrations in a matrix wherein the filaments having good damping properties are about 30 to 50% by volume of the total quantity of filaments. The filaments having high damping properties are in particular filaments made of UHMWPE and the filaments having low damping properties are glass fibers or carbon fibers. The composite articles produced from the filaments are embedded in a matrix, in particular a matrix made of epoxy resin.

EP 3 006 489 discloses composite fabrics composed by carbon filaments weaved with the filaments of a high-performance polyethylene fiber formed by a linear polyethylene with ultra-high molar mass (UHMWPE) and impregnated in a matrix of a low curing temperature epoxy resin and cured at a temperature of at most 100° C. The fabric includes the use of carbon fiber alternate to the UHMWPE fiber in one of the weaving directions (weft or warp) and the use of the sole UHMWPE fiber in the other direction at right angles. The fabric includes % 50 UHMWPE ve % 50 carbon fibers by weight.

U.S. Pat. No. 4,983,433 discloses a reinforcement for a fiber reinforced plastic which is a double mixed-woven or knitted fabric of two kinds of filaments. One of the filaments used is an UHMWPE filament occupying 60 to 90% of the total surface area of said fabric. The other filaments can be carbon or glass filaments and occupy 60 to 90% of the total back surface area of the fabric.

WO 2018/002229 discloses a multilayer hybrid composite including: at least one layer of a fabric A including from 0 to 20 vol % high performance polymer fibers, preferably UHMWPE, and from 100 to 80 vol % fibers selected from the group consisting of glass fibers and carbon fibers; at least one layer of a fabric B including from 20 to 70 vol % high performance polymer fibers, preferably UHMWPE, and from 80 to 20 vol % fibers selected from the group consisting of glass fibers and carbon fibers; and a matrix material.

WO 2019/025641 discloses hybrid fabrics including a high-performance polyethylene (HPPE) fiber and a non-polymeric fiber, wherein the cross-sectional area of the HPPE fiber is equal to or smaller than the cross-sectional area of the non-polymeric fiber. Preferably, the hybrid fabric includes % 15-50 by volume of HPPE fiber.

CN 101736480 and CN 101768809 disclose hybrid fabrics including carbon fiber and UHMWPE fiber. The UHMWPE and carbon fibers can be mixed in the warp, weft, or warp and weft directions of the fabric. The document also discloses composite materials produced using said hybrid fabrics.

Hu and colleagues disclose laminates including two dimensional woven fabrics made of UHMWPE and carbon fibers at a carbon: UHMWPE ratio of 2:1 in weft and warp direction in order to achieve improved impact resistance (Hu, Yuan, et al. “Damage tolerance of 2-dimentional UHMWPE/CF hybrid woven laminates subjected to low-velocity impact.” Materials & Design 191 (2020): 108604).

However, it is possible to improve the properties of the UHMWPE fibers used in order to obtain a hybrid fabric having improved impact resistance.

### SUMMARY

The present invention discloses a hybrid fabric including carbon fibers and UHMWPE fibers, wherein UHMWPE fibers are twisted in order to improve their tensile strength and thus improve the impact resistance properties of the hybrid fabric. The hybrid fabric is preferably a woven fabric including 50-70% carbon fibers and 30-50% UHMWPE fibers by weight. The hybrid fabric of the present invention can be used in a variety of fields making use of prepreg materials in impact resistant articles, such as in industrial, construction, and military applications.

### DETAILED DESCRIPTION OF THE EMBODIMENTS

As used herein, the terms “fiber” or “filament” refer to an elongated body for which the length dimension is greater than the transverse or width dimension and they may be circular, flat, oblong, or irregular in cross-section. A single fiber may be formed from just one filament or from multiple filaments. The term “fabric” refers to a plurality of fibers that have been arranged so as to form a generally continuous sheet and may include woven, unidirectional, and/or non-woven fabric/fiber matrices made using the fibers or filaments as described herein. The term “hybrid fabric” refers to a fabric including at least two different kinds of fibers or filaments, i.e., the fibers or filaments have different chemical structures and properties.

The term “denier” refers to the unit of linear density (titer), equal to the mass in grams per 9000 meters of fiber. An alternative measure for the titer of a fiber is tex representing the mass (in grams) of said fiber per 1000 meters of said fiber. The term “tenacity” refers to the tensile stress expressed as force per unit linear density of an unstressed specimen (N/tex, g/denier, GPa). The term “tensile modulus” refers to the ratio of the change in tenacity to the change in strain (N/tex, GPa).

The two kinds of fibers used in the hybrid fabric of the present invention will be described further below:

Carbon fiber: The carbon fiber may have a titer of from 100 dtex to 100000 dtex, preferably of from 100 dtex to 50000 dtex. In particular, carbon fiber may have a titer of between 500 and 40000 dtex, in particular between 650 and 32000 dtex and may have a filament count of between 1000 and 48000. The Carbon fiber may be purchased from commercially available products.

UHMWPE fiber: In the context of the present invention ultrahigh molecular weight is considered as being of a weight average molecular weight of at least 400 kg/mol. The UHMWPE fibers of the first yarn may be manufactured according to any technique known in the art, e.g. by melt, solution or gel spinning, or purchased from commercially available products. The UHMWPE fibers may further contain small amounts, generally less than 5%, preferably less than 3% of customary additives, such as antioxidants, thermal stabilizers, colorants, flow promoters, etc. The fibers may be of any suitable denier, such as, for example, 20 to 4800 deniers, more preferably from 800 to 4800 denier, most preferably from 1600 to 4800 denier.

It was found that the tensile strength of UHMWPE fibers can be improved by twisting the fibers. For example, it was found that one UHMWPE fiber of 4800 denier has higher tensile strength than twisting three UHMWPE fibers of 1600 denier together (Table 1). It was also found that the tensile strength of UHMWPE fibers increased with increasing number of twists per meter, reaching a maximum value at 55-65 twists per meter and decreasing at greater number of twists per meter (Table 2). Therefore, the properties of UHMWPE fibers can be adjusted as desired based on the application by twisting. Hybrid fabrics produced using twisted UHMWPE fibers have improved impact resistance properties.

TABLE 4
Comparison of the physical properties of three 1600 denier UHMWPE fibers and one
4800 denier UHMWPE fiber twisted together at varying number of twists per meter

| | Twists/m | | | | | |
|---|---|---|---|---|---|---|
| | 50 | | 80 | | 120 | |
| Fiber | 1600 × 3 | 4800 × 1 | 1600 × 3 | 4800 × 1 | 1600 × 3 | 4800 × 1 |
| Tensile strength (N) | 1636 | 1728 | 1486 | 1617 | 1306 | 1370 |
| Elongation at break (%) | 4.56 | 4.91 | 5.05 | 5.07 | 5.87 | 5.69 |
| Tenacity (cN/Dtex) | 34.08 | 36.00 | 30.96 | 33.68 | 27.22 | 28.54 |
| Tensile modulus (cN/Dtex) | 970 | 990 | 809 | 878 | 706 | 751 |
| Maximum load (mJ) | 8706 | 9962 | 8037 | 8884 | 7401 | 7421 |
| Toughness (J) | 9.04 | 10.41 | 8.42 | 9.07 | 7.70 | 7.63 |

TABLE 5
Physical properties of 4800 denier UHMWPE fibers at varying number of twists per meter

| Twists/m | 0 | 20 | 40 | 50 | 55 | 60 | 65 | 80 | 120 |
|---|---|---|---|---|---|---|---|---|---|
| Tensile strength (N) | 1498 | 1527 | 1662 | 1728 | 1762 | 1669 | 1660 | 1617 | 1370 |
| Elongation at break (%) | 3.83 | 4.27 | 4.31 | 4.91 | 5.37 | 5.02 | 5.01 | 5.07 | 5.69 |
| Tenacity (cN/Dtex) | 31.22 | 31.81 | 34.63 | 36.00 | 36.71 | 34.77 | 34.58 | 33.68 | 28.54 |
| Tensile modulus (cN/Dtex) | 1113 | 1074 | 1092 | 990 | 947 | 932 | 926 | 878 | 751 |
| Maximum load (mJ) | 6486 | 7956 | 8700 | 9962 | 10849 | 9461 | 9742 | 8884 | 7421 |
| Toughness (J) | 6.71 | 8.38 | 9.11 | 10.41 | 11.61 | 9.85 | 9.81 | 9.07 | 7.63 |

The hybrid fabric of the invention includes 50-70% carbon fibers and 30-50% UHMWPE fibers by weight. More preferably, the hybrid fabric includes 55-65% carbon fibers and 35-45% UHMWPE fibers by weight. In a most preferred embodiment, the hybrid fabric includes 60% carbon fibers and 40% UHMWPE fibers by weight. It was found that this ratio results in the highest impact resistance properties.

The hybrid fabric according to the invention is preferably a woven fabric that typically includes one single weft yarn or multiple weft yarns, that may have similar or different composition and one single warp yarn or multiple weft yarns, that may have similar or different composition. The UHMWPE and carbon fibers can be mixed in the warp, weft, or warp and weft directions of the hybrid fabric. When fibers are mixed in the warp direction, the warp direction includes UHMWPE and carbon fibers while the weft direction includes UHMWPE or carbon fibers. When fibers are mixed in the weft direction, the weft direction includes UHMWPE and carbon fibers while the warp direction includes UHMWPE or carbon fibers. When fibers are mixed in the warp and weft directions, both the warp direction and the weft direction include UHMWPE and carbon fibers. In a preferred embodiment of the invention, UHMWPE and carbon fibers are mixed in the warp and weft directions. The ratio of UHMWPE to carbon fibers may be equal, or different in warp and weft directions. In a preferred embodiment, ratio of UHMWPE to carbon fibers are equal in warp and weft directions.

Preferably, the type of woven hybrid fabric is plain weave fabric, twill weave fabric, satin weave fabric, unidirectional fabric, or multilayer multi-axial fabric.

The areal density of the hybrid fabric is preferably between 10 and 3000 g/m². More preferably, the areal density of the hybrid fabric is between 100 and 1500 g/m² or between 150 and 1000 g/m².

The hybrid fabric of the present invention may be used in composites. A composite refers to a material including at least one fabric and a material in a different form, such as a matrix material, e.g., a co(polymer) resin impregnated through the fabric and/or coated on the fabric. The matrix material is typically a liquid (co)polymer resin impregnated in between the fabric and optionally subsequently hardened. Hardening or curing may be done by any means known in the art, e.g., a chemical reaction, or by solidifying from molten to solid state. Suitable examples of matrix material include but are not limited to thermoplastic resins, epoxy resins, polyester or vinyl ester resins, or phenolic resins.

The hybrid fabric according to the present invention shows improved tensile strength and modulus, while maintaining high impact resistance properties, and thus enabling more and various application opportunities.

Preferably, the composite obtained by applying the hybrid fabric shows the following properties: tensile modulus of at least 28 GPa, more preferably of at least 32 GPa; tensile strength of at least 475 MPa, preferably of at least 535 MPa; and high impact properties, i.e., high energy absorbing capability like at least 40, preferably of at least 46 J.

### EXAMPLES

The following examples are provided to illustrate the present invention and are not intended to limit the scope of the invention.

### Materials

Commercially available 24K carbon fiber (24000 filaments) having a tensile modulus of 239 GPa, a titer of 1600 tex and a tenacity of 4.2 GPa was used.

Three UHMWPE filaments of 1600 denier were joined by ring spinning at 60 twists per meter. The resulting UHMWPE fiber had a tensile modulus of 775 cN/dtex, a titer of 4800 denier and a tenacity of 28 cN/dtex.

### Hybrid Fabric

A hybrid fabric of 2×2 twill arrangement including 60% carbon and 40% UHMWPE by weight was produced. The weft and the warp directions included UHMWPE fibers and carbon fibers in a ratio of 2:1. Weft density was set at 3.8. The areal density of hybrid fabric was 1000 g/m².

The physical properties of the hybrid fabric described above in comparison with 100% carbon fabric is given in Table 3 below. Since UHMWPE fiber has a lower density and is cheaper than carbon fiber the hybrid fabric made from carbon and UHMWPE provides a light-weight solution that has a much higher energy absorption capability than 100% carbon fabric.

TABLE 6
Physical properties of 100% carbon fabric and hybrid
fabric including 60% carbon and 40% UHMWPE by weight

| | Carbon fabric | Hybrid fabric |
|---|---|---|
| Modulus of Elasticity (GPa) | 63 | 32.32 |
| Tensile Strength (MPa) | 718 | 535 |
| Energy Absorption (J) | 22.8 | 46.6 |
| Density (g/cm³) | 1.78 | 1.46 |

In a nutshell, the present invention proposes a hybrid fabric including carbon fibers and ultra-high molecular weight polyethylene fibers wherein; said hybrid fabric is a woven fabric, and said hybrid fabric includes 50-70% carbon fibers and 30-50% UHMWPE fibers by weight.

In one variation of the present invention, said ultra-high molecular weight polyethylene fibers have between 20 to 80 twists per meter.

In a further variation of the present invention, said ultra-high molecular weight polyethylene fibers have between 40 to 80 twists per meter.

In a further variation of the present invention, said ultra-high molecular weight polyethylene fibers have between 55 to 65 twists per meter.

In a further variation of the present invention, said ultra-high molecular weight polyethylene fibers have a titer between 1600 to 4800 denier.

In a further variation of the present invention, said ultra-high molecular weight polyethylene fibers are monofilament fibers.

In a further variation of the present invention, said hybrid fabric includes 55-65% carbon fibers and 35-45% ultra-high molecular weight polyethylene fibers by weight.

In a further variation of the present invention, said hybrid fabric includes 60% carbon fibers and 40% ultra-high molecular weight polyethylene fibers by weight.

In a further variation of the present invention, said hybrid fabric is a plain weave fabric, twill weave fabric, satin weave fabric, unidirectional fabric, or multilayer multi-axial fabric.

In a further variation of the present invention, said carbon fibers ultra-high molecular weight polyethylene fibers are mixed in the warp, weft, or warp and weft directions.

The present invention also proposes a composite including at least one layer of the hybrid fabric described above.

What is claimed is:

1. A hybrid fabric comprising carbon fibers and ultra-high molecular weight polyethylene (UHMWPE) fibers, wherein
the hybrid fabric is a woven fabric, and
the hybrid fabric comprises 50-70% of the carbon fibers and 30-50% of the UHMWPE fibers by weight.

2. The hybrid fabric according to claim 1, wherein the ultra-high molecular weight polyethylene fibers have between 20 to 80 twists per meter.

3. The hybrid fabric according to claim 2, wherein the ultra-high molecular weight polyethylene fibers have between 40 to 80 twists per meter.

4. The hybrid fabric according to claim 3, wherein the ultra-high molecular weight polyethylene fibers have between 55 to 65 twists per meter.

5. The hybrid fabric according to claim 1, wherein the ultra-high molecular weight polyethylene fibers have a titer between 1600 to 4800 denier.

6. The hybrid fabric according to claim 1, wherein the ultra-high molecular weight polyethylene fibers are monofilament fibers.

7. The hybrid fabric according to claim 1, wherein the hybrid fabric comprises 55-65% of the carbon fibers and 35-45% of the ultra-high molecular weight polyethylene fibers by weight.

8. The hybrid fabric according to claim 7, wherein the hybrid fabric comprises 60% of the carbon fibers and 40% of the ultra-high molecular weight polyethylene fibers by weight.

9. The hybrid fabric according to claim 1, wherein the hybrid fabric is a plain weave fabric, a twill weave fabric, a satin weave fabric, an unidirectional fabric, or a multilayer multi-axial fabric.

10. The hybrid fabric according to claim 1, wherein the carbon fibers and the ultra-high molecular weight polyethylene fibers are mixed in warp, weft, or warp and weft directions.

11. A composite comprising at least one layer of the hybrid fabric according to claim 1.

12. The hybrid fabric according to claim 2, wherein the ultra-high molecular weight polyethylene fibers have a titer between 1600 to 4800 denier.

13. The hybrid fabric according to claim 3, wherein the ultra-high molecular weight polyethylene fibers have a titer between 1600 to 4800 denier.

14. The hybrid fabric according to claim 4, wherein the ultra-high molecular weight polyethylene fibers have a titer between 1600 to 4800 denier.

15. The hybrid fabric according to claim 2, wherein the ultra-high molecular weight polyethylene fibers are monofilament fibers.

16. The hybrid fabric according to claim 3, wherein the ultra-high molecular weight polyethylene fibers are monofilament fibers.

17. The hybrid fabric according to claim 4, wherein the ultra-high molecular weight polyethylene fibers are monofilament fibers.

18. The hybrid fabric according to claim 5, wherein the ultra-high molecular weight polyethylene fibers are monofilament fibers.

19. The hybrid fabric according to claim 2, wherein the hybrid fabric comprises 55-65% of the carbon fibers and 35-45% of the ultra-high molecular weight polyethylene fibers by weight.

20. The hybrid fabric according to claim 3, wherein the hybrid fabric comprises 55-65% of the carbon fibers and 35-45% of the ultra-high molecular weight polyethylene fibers by weight.
